(19) United States
(12) Patent Application Publication
(10) Pub. No.: US 2020/0085547 A1
(43) Pub. Date: Mar. 19, 2020

(54) METHOD FOR FORMING AND SETTING DENTURE

(71) Applicants: Chung-Pin Huang, New Taipei City (TW); Emilio Ivan Arguello, Denver, CO (US)

(72) Inventor: Emilio Ivan Arguello, Denver, CO (US)

(21) Appl. No.: 16/132,459

(22) Filed: Sep. 16, 2018

(51) Int. Cl. A61C 13/00; A61C 9/00

(52) U.S. Cl. CPC A61C 13/0004; A61C 13/0001; A61C 13/0019; A61C 9/0053

(57) ABSTRACT

A method for forming and setting a denture has the following steps: using a stereoscopic scanner to capture a patient's maxillary, mandibular gum shapes to generate stereoscopic maxillary, mandibular gum data and an occlusion record of a patient's maxilla and mandible; using a computer tomography scanner to scan patient's maxilla, mandible shapes to generate tomographic maxilla, mandible data; using a 3D processing device to consolidate the stereoscopic maxillary, mandibular gum data, occlusion record of a patient's maxilla and mandible, tomographic maxilla, mandible data to generate 3D full-tooth data; planning detailed positions and sizes of a upper (lower) prosthesis adapted to set on the patient maxilla (mandible) side, a plurality of upper (lower) fixing elements for fixing the upper (lower) prosthesis through the 3D full-tooth data; and making the upper, lower prostheses, and using each upper (lower) fixing element to implant the upper (lower) prosthesis into the patient's maxilla (mandible).

### TECHNICAL FIELD OF THE INVENTION

The present invention relates to a method for forming and setting a denture, and more particularly to a method for forming and setting a denture capable of allowing the size and setting position thereof to be accurately matched with a patient so as to facilitate the installment use thereof.

### DESCRIPTION OF THE PRIOR ART

Teeth take up a very important position when ingesting general solid foods, but they may be worn out, shed, eroded, etc. due to factors such as long-term use, aging, disease, poor physical condition, or poor cleaning, which not only affects a person's appearance and speech but general solid food intake, possibly causing malnutrition, hidden hunger, weakness, or indigestion, so that conventional denture components are researched in the dental industry.

Upon denture making, the upper and lower teeth of a patient are first scanned with computerized tomography, and gypsum film, etc. are then produced according to the scanning result to assist in judging on how to make conventional denture components and judging whether the fabricated denture components are suitable for wearing and occlusion.

But, since the occlusion of the upper row of teeth and the lower row of teeth involves the cooperation of cartilage and muscles, only depending on the above gypsum film for the judgement, inevitably, there is an error with actual occlusion, resulting in more time and efforts for testing and modification, and causing embarrassment to patients.

### SUMMARY OF THE INVENTION

The main objective of the present invention is to provide a method for forming and setting a denture, improving the installment and occlusion accuracy of a patient's prosthesis.

To achieve the objective mentioned above, the present invention is to provide a method for forming and setting a denture, having the following steps: (a) using at least one stereoscopic scanner to capture a patient's maxillary gum shape and mandibular gum shape to generate stereoscopic maxillary gum data, stereoscopic mandibular gum data and an occlusion record of a patient's maxilla and mandible; (b) using at least one computer tomography scanner to scan a patient's maxilla shape and mandible shape to generate tomographic maxilla data and tomographic mandible data; (c) using at least one 3D processing device to consolidate the stereoscopic maxillary gum data, stereoscopic mandibular gum data, occlusion record of a patient's maxilla and mandible, tomographic maxilla data and tomographic mandible data to generate 3D full-tooth data; (d) planning detailed positions and sizes of at least one upper prosthesis adapted to set on the patient maxilla side, a plurality of upper fixing elements for fixing the upper prosthesis, at least one lower prosthesis adapted to set on the patient's mandible side and a plurality of lower fixing elements for fixing the lower prosthesis through the 3D full-tooth data; and (e) making the upper prosthesis and lower prosthesis, and using each upper fixing element to implant the upper prosthesis into the patient's maxilla, and using each lower fixing element to implant the lower prosthesis into the patient's mandible.

The upper prosthesis and lower prosthesis is made so and the setting positions and occlusion positions thereof will conform to actual patient's conditions. With the above technologies, the problems existing in conventional denture elements such as large error and embarrassment caused to patients can be solved, thereby obtaining the effect of matching the size and setting position with a patient accurately so as to facilitate the installment use.

### BRIEF DESCRIPTION OF THE DRAWINGS

FIG. 1 is a flow chart of a preferred embodiment of the present invention;

FIG. 2 is a schematically perspective view of the embodiment of the present invention upon stereoscopic scanning;

FIG. 3 is a schematically perspective view of the embodiment of the present invention upon tomographic scanning;

FIG. 4 is a schematically perspective view of the embodiment of the present invention upon consolidation processing;

FIG. 5 is a schematically perspective view of the embodiment of the present invention upon planning; and

FIG. 6 is a schematically perspective view of the embodiment of the present invention upon implantation.

### DETAILED DESCRIPTION OF THE PREFERRED EMBODIMENTS

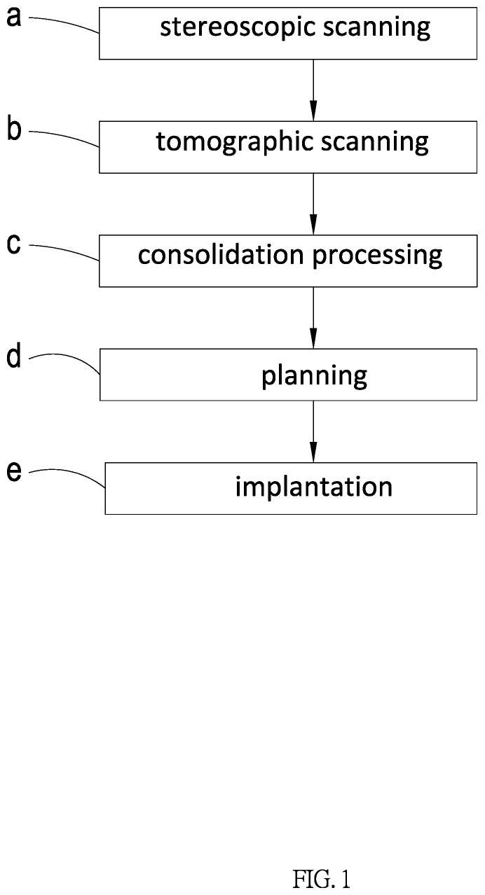

Referring to FIGS. 1 to 6, a method for forming and setting a denture of the present invention mainly includes the following steps: (a) stereoscopic scanning, (b) tomographic scanning, (c) consolidation processing, (d) planning and (e) implantation.

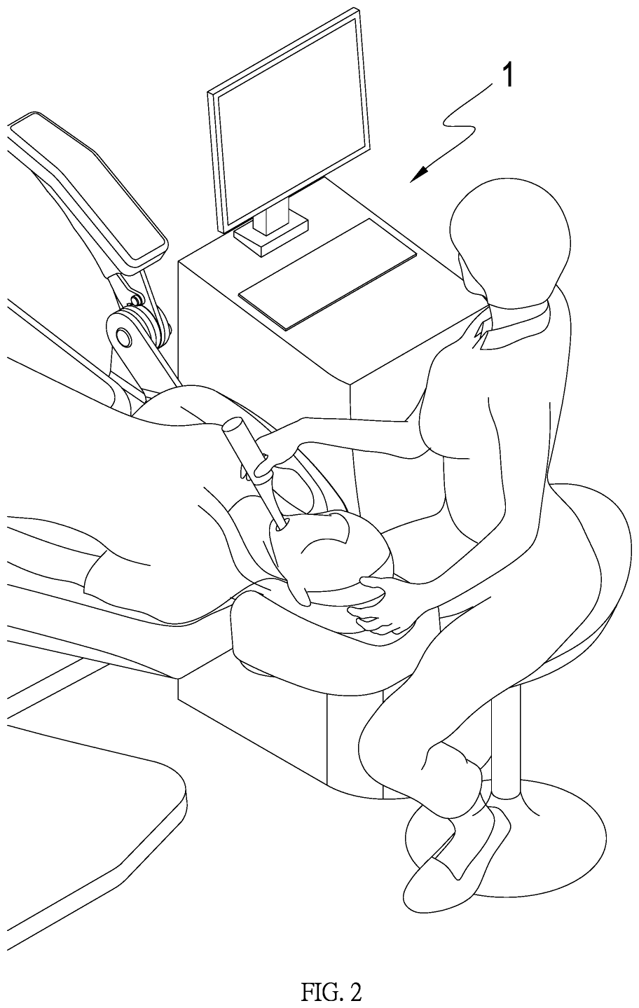

Step (a) stereoscopic scanning: referring to FIG. 2, capturing the shape of the maxillary gum and the shape of the mandibular gum of a patient with at least one stereoscopic scanner 1 (in this embodiment, a hand-held stereoscopic scanner is combined with a screen) to generate stereoscopic maxillary gum data, stereoscopic mandibular gum data and an occlusion record of a maxilla and mandible. But, when step (a) is processed, if the patient's maxilla or mandible has no tooth, step (a1) must be processed: allowing the patient to wear proper traditional dentures, generating stereoscopic upper denture data, stereoscopic lower denture data and occlusion data of dentures; if the patient has no traditional denture, step (a0) must be processed: making traditional dentures, thereby not only knowing the patient's actual maxillary gum shape and mandibular gum shape yet capable of obtaining actual occlusion record of the patient's maxilla and mandible, thereby allowing subsequent making and setting of upper prosthesis 41 and lower prosthesis 42 (known as denture or false teeth) to be more accurately matched with the patient.

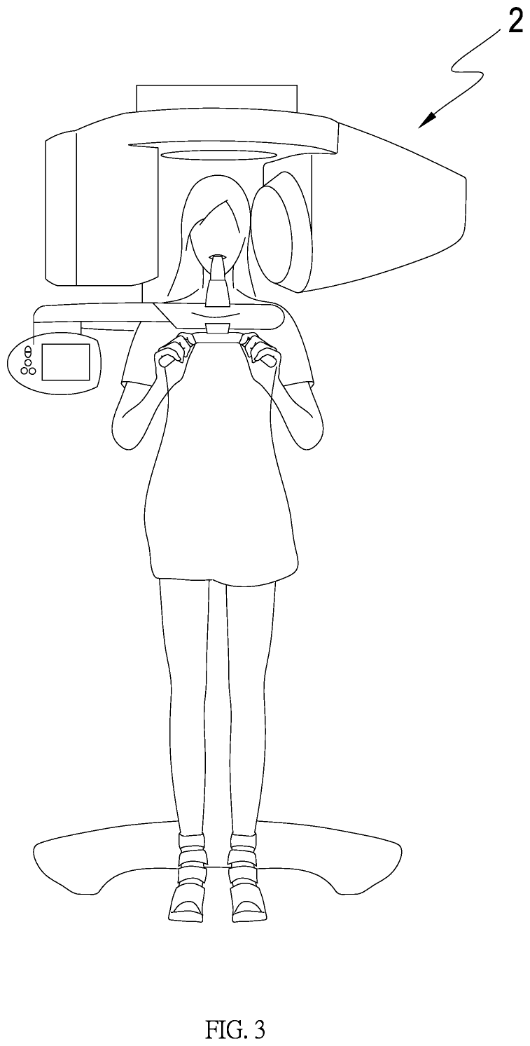

Step (b) tomographic scamming referring to FIG. 3, using at least one computer tomography scanner (CT scanner) 2 (in this embodiment, a cone beam CT scanner is used) to scan the patient's maxilla shape and mandible shape to generate tomographic maxilla data, tomographic mandible data. But, a patient without tooth still needs to be processed with step (b1) when step (b) is processed: allowing the patient to wear traditional dentures and the dentures to be scanned with the CT scanner 2 to generate tomographic upper denture data and tomographic lower denture data to increase the accuracy.

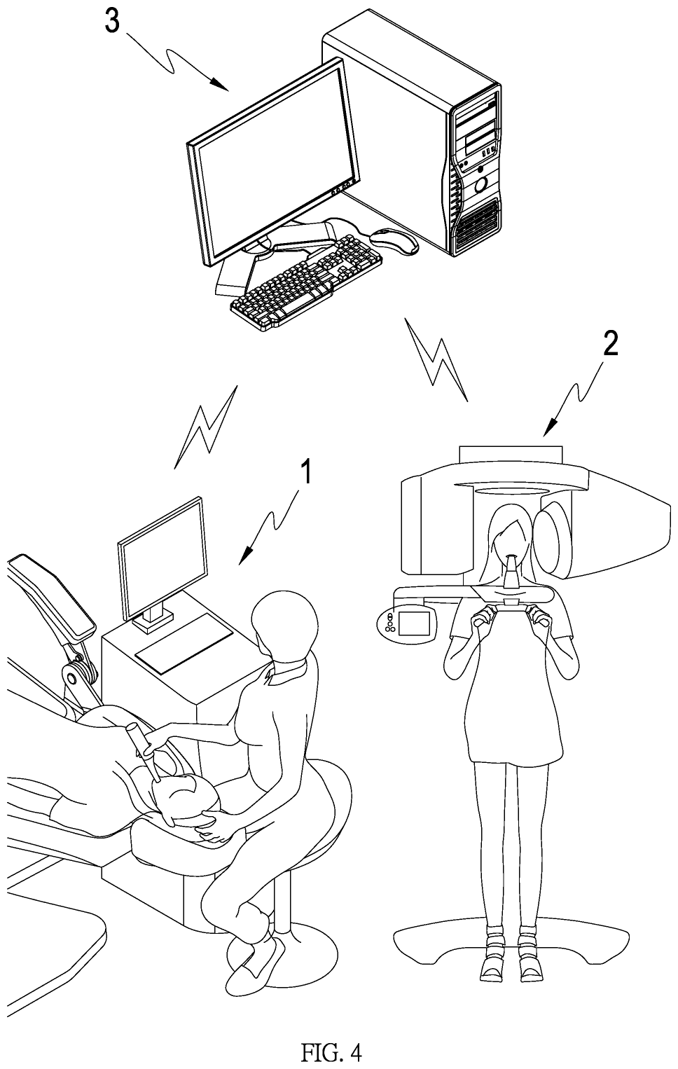

Step (c) consolidation processing: referring to FIG. 4, using at least one 3D processing device 3 (in the embodiment, a computer with full-tooth simulation software is used) to consolidate the stereoscopic maxillary gum data, stereoscopic mandibular gum data, occlusion record of a patient's maxilla and mandible, tomographic maxilla data and tomographic mandible data by a prosthesis technician to generate 3D full-tooth data. In addition, as previously mentioned, the 3D processing device 3 will still consolidate stereoscopic upper denture data, stereoscopic lower denture data, an occlusion record of the dentures, tomographic upper denture data and tomographic lower denture data to generate 3D full-tooth data when a patient has no tooth; the technician may also use the 3D processing device 3 under a dentist's permission to generate 3D digital virtual prosthesis data according to the 3D full-tooth data for the patient's viewing confirmation, or may further make a prototype (such as using 3D printing technology) for patient trial confirmation, and a trial result may also be included in the following step (d) for reference.

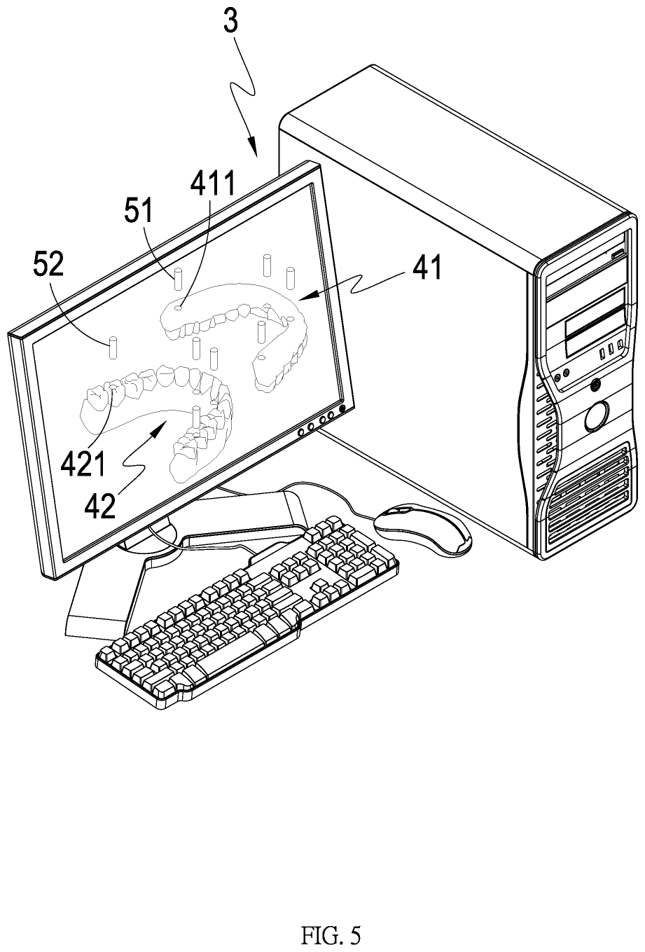

Step (d) planning referring to FIG. 5, planning the detailed positions and sizes of at least one upper prosthesis 41 set on the patient's maxilla side, a plurality of upper fixing elements 51 for fixing the upper prosthesis 441, at least one lower prosthesis 42 set on the patient's mandible side, a plurality of lower fixing elements 52 for fixing the lower prothesis 42 through the 3D full-tooth data, where each upper fixing element 51 and each lower fixing element 52 respectively include current market-available bone fixation sleeve, fixation nail, spiral or cement, and the upper prosthesis 41 will be formed with a plurality of upper fixation holes 411 allowing each upper fixing element 51 to be passed through and the lower prosthesis 42 will be formed with a plurality of lower fixation holes 421 allowing each lower fixing element 52 to be passed through, which can then plan the required shapes and setting positions of the upper prosthesis 41 and lower prosthesis 42 (corresponding to the patient's maxillary gum, maxilla, mandibular gum or mandible) and the fixation ways and required parts (the fixation hole 411, lower fixation hole 421, upper fixing element 51 and lower fixing element 52), thereby facilitating processing the subsequent step.

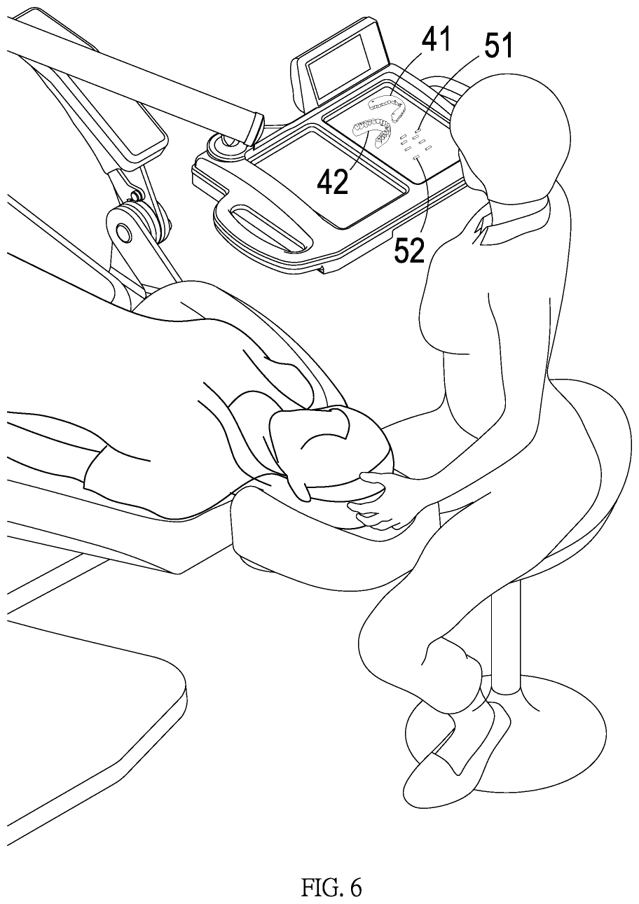

Final step (e) implantation: referring to FIG. 6, making the upper prosthesis 41 and lower prosthesis 42, and implanting the upper prosthesis 41 into a planned setting position of the patient's maxilla with each upper fixing element 51 and implanting the lower prosthesis 42 into a planned setting position of the patient's mandible with each lower fixing element 52; thereafter, configuring at least one filler to seal each upper fixing element 51 and each lower fixing element 52 on each fixation hole 411 and each lower fixation hole 42 to prevent each upper fixing element 51 or each lower fixing element 52 from being polluted, rusted or damaged after the implantation is completed.

Therefore, the method for forming and setting a denture of the present invention has the following advantages over the prior arts: allowing the present invention to achieve the size and setting position being capable of being matched with a patient so as to facilitate installment use.

I claim:

1. A method for forming and setting a denture, having the following steps:
(a) using at least one stereoscopic scanner to capture a patient's maxillary gum shape and mandibular gum shape to generate stereoscopic maxillary gum data, stereoscopic mandibular gum data and an occlusion record of a patient's maxilla and mandible;
(b) using at least one computer tomography scanner to scan a patient's maxilla shape and mandible shape to generate tomographic maxilla data and tomographic mandible data;
(c) using at least one 3D processing device to consolidate said stereoscopic maxillary gum data, stereoscopic mandibular gum data, occlusion record of a patient's maxilla and mandible, tomographic maxilla data and tomographic mandible data to generate 3D full-tooth data;
(d) planning detailed positions and sizes of at least one upper prosthesis adapted to set on said patient maxilla side, a plurality of upper fixing elements for fixing said upper prosthesis, at least one lower prosthesis adapted to set on said patient's mandible side and a plurality of lower fixing elements for fixing said lower prosthesis through said 3D full-tooth data; and
(e) making said upper prosthesis and lower prosthesis, and using each said upper fixing element to implant said upper prosthesis into said patient's maxilla, and using each said lower fixing element to implant said lower prosthesis into said patient's mandible.

2. The method according to claim 1, wherein when step (a) using at least one stereoscopic scanner is processed, if said patient's maxilla or mandible has no tooth, processing step (a1): making said patient wear a proper traditional denture, and then capturing and generating stereoscopic upper denture data, stereoscopic lower denture data and occlusion data of said dentures with said stereoscopic scanner.

3. The method according to claim 2, wherein step (a0): making said traditional denture must first be processed if said patient has no said traditional denture before step (a) using at least one stereoscopic scanner is processed.

4. The method according to claim 2, wherein when step (b) using at least one computer tomography scanner is processed, said patent having no tooth still needs to process step (b1): allowing said patient to wear said traditional denture and scanning said denture with said computer tomography scanner to generate tomographic upper denture data and tomographic lower denture data.

5. The method according to claim 4, wherein said 3D full-tooth data in step (c) using at least one 3D processing device also consolidates said stereoscopic upper denture data, stereoscopic lower denture data, said occlusion data of dentures, tomographic upper denture data and tomographic lower denture data.

6. The method according to claim 5, wherein said 3D processing device is allowed to generate 3D digital virtual prosthesis data according to said 3D full-tooth data to match with said patient having no tooth after step (c) using at least one 3D processing device.

7. The method according to claim 1, said computer tomography scanner in step (b) using at least one computer tomography scanner is a cone beam computer tomography scanner.

8. The method according to claim 1, wherein each said upper fixing element and each said lower fixing element in step (d) planning detailed positions and sizes respectively comprise bone fixation sleeve, fixation nail, spiral or cement.

9. The method according to claim 1, where said upper prosthesis in step (d) planning detailed positions and sizes is formed with a plurality of upper fixation holes allowing each said upper fixing element to be passed through, and said lower prosthesis in step (d) planning detailed positions and sizes is formed with a plurality of lower fixation holes allowing each said lower fixing element to be passed through.

10. The method according to claim 9, wherein each said upper fixation hole and each said lower fixation hole are respectively configured with at least one filler adapted to seal each said upper fixing element and each said lower fixing element.
